(19) United States
(12) Patent Application Publication
(10) Pub. No.: US 2026/0211605 A1
(43) Pub. Date: Jul. 23, 2026

(54) INFORMATION PROMPTING METHOD AND APPARATUS

(71) Applicant: HUNAN MGTV.COM INTERACTIVE ENTERTAINMENT MEDIA CO., LTD, Hunan (CN)

(72) Inventors: Guangbin LIU, Hunan (CN); Pingping BAI, Hunan (CN); Yunjiang LIU, Hunan (CN); Junhao OUYANG, Hunan (CN); Wenxian ZHAO, Hunan (CN)

(73) Assignee: HUNAN MGTV.COM INTERACTIVE ENTERTAINMENT MEDIA CO., LTD, Hunan (CN)

(21) Appl. No.: 19/122,503

(22) PCT Filed: Dec. 26, 2022
(86) PCT No.: PCT/CN2022/141959

§ 371 Date: Apr. 18, 2025

(30) Foreign Application Priority Data
Oct. 21, 2022 (CN) 202211293176.1

(51) Int. Cl. G06F 3/14; G06F 3/04817; H04N 21/258; H04N 21/41; H04N 21/431; H04W 8/00; H04W 84/12

(52) U.S. Cl. CPC G06F 3/1454; G06F 3/04817; H04N 21/25825; H04N 21/4108; H04N 21/4312; H04W 8/005; H04W 84/12

(57) ABSTRACT

The present application provides an information prompting method and apparatus. The method comprises: when a first media playback application of a mobile terminal starts multimedia playback, if the mobile terminal is located in a wireless local area network of a specified type, detecting whether at least one candidate terminal device exists in the wireless local area network; if the at least one candidate terminal device exists in the wireless local area network, detecting whether the candidate terminal device enables a specified port, wherein enabling of the specified port by the candidate terminal device represents that the candidate terminal device is a terminal device associated with a set type of screen; and if at least one target terminal device enabling the specified port exists among the at least one candidate terminal device, outputting a first icon prompt in a multimedia playback window of the first media playback application, the first icon prompt being used for prompting that a terminal device provided with the set type of screen exists in the wireless local area network where the mobile terminal is located. The solution of the present application can reduce resource consumption caused by invalid screen mirroring.

This application claims the priority to Chinese Patent Application No. 202211293176.1 titled “INFORMATION PROMPTING METHOD AND APPARATUS”, filed on Oct. 21, 2022 with the China National Intellectual Property Administration, which is incorporated herein by reference in its entirety.

### FIELD

The present disclosure relates to the field of Internet technology, and in particular to an information prompting method and an information prompting apparatus.

### BACKGROUND

In order to improve a viewing effect of a video or other multimedia, the video or other multimedia data played on a mobile terminal is often projected onto a smart television or other smart device with a large screen for display.

During a process of playing multimedia content on a multimedia player application of the mobile terminal, if a user clicks a projection icon on a multimedia playback window of the multimedia player application, the mobile terminal initiates a projection procedure, and projects, upon detecting a target device that supports projection, the multimedia content played by the multimedia player application onto the target device. In some cases, however, after the user clicks the projection icon, the mobile terminal fails to access a suitable wireless local area network or fails to detect the target device that supports projection, failing to achieve the projection while wasting processing resources of the mobile terminal for processing the projection operation.

### SUMMARY

In view of this, the present disclosure provides an information prompting method and an information prompting apparatus, to reduce resource consumption caused by failure of projection.

To achieve the above objective, an information prompting method is provided in the present disclosure. The information prompting method includes:
detecting, in response to a first media player application of a mobile terminal initiating multimedia playback and the mobile terminal being in a wireless local area network of a specified type, whether at least one candidate terminal device other than the mobile terminal is in the wireless local area network;
detecting, in response to the at least one candidate terminal device being in the wireless local area network, whether a specified port of the at least one candidate terminal device is activated, activation of the specified port of the at least one candidate terminal device indicates that the candidate terminal device is associated with a screen of a preset type; and
outputting, in response to the at least one candidate terminal device including at least one target terminal device whose specified port is activated, a first icon prompt to a multimedia playback window of the first media player application, where the first icon prompt is for prompting existence of a terminal device with the screen of the preset type in the wireless local area network where the mobile terminal is located.

In a possible implementation, the information prompting method further includes:
acquiring, in response to the at least one candidate terminal device including the at least one target terminal device whose specified port is activated, a first media access control address of the at least one target terminal device and a second media access control address of a router in the wireless local area network;
determining, for each of the at least one target terminal device, whether an access record of the target terminal device is in an application server based on the first media access control address of the target terminal device and the second media access control address of the router, where the application server is capable of outputting projection content and corresponds to a second media player application of a specified type; and
outputting, in response to the access record of the at least one target terminal device being in the application server, a second icon prompt to the multimedia playback window of the first media player application, where the second icon prompt is for prompting existence of a terminal device with the screen of the preset type and installed with the second media player application in the wireless local area network.

In a possible implementation, the information prompting method further includes: outputting, in response to none of the access record of the at least one target terminal device being in the application server, a third icon prompt to the multimedia playback window of the first media player application, where the third icon prompt is for prompting a user to install the second media player application on the terminal device with the screen of the preset type in the wireless local area network.

In a possible implementation, the information prompting method further includes:
acquiring, in response to the access record of the at least one target terminal device being in the application server, service state information of the at least one target terminal device, where the service state information includes player application identification information of a player application currently started and running on the at least one target terminal device; and
outputting a fourth icon prompt in response to the player application identification information corresponding to the at least one target terminal device including identification information of the second media player application, where the fourth icon prompt is for prompting a user that a terminal device capable of projection is in the wireless local area network.

In a possible implementation, the detecting whether at least one candidate terminal device other than the mobile terminal is in the wireless local area network includes:
obtaining a first IP address of the mobile terminal;
determining multiple second IP addresses configurable in the wireless local area network other than the first IP address; and
sending a test packet to each of the multiple second IP addresses to determine whether a candidate terminal device corresponding to the second IP address in the wireless local area network;
where determining that the at least one candidate terminal device is in the wireless local area network includes: determining, on receiving a test response packet returned from at least one of the multiple second IP addresses, that the at least one candidate terminal device corresponding to the at least one second IP address is in the wireless local area network, where the test response packet is a response data packet regarding the test packet.

In a possible implementation, the detecting whether a specified port of the at least one candidate terminal device is activated includes: sending a connection request to the specified port of the at least one candidate terminal device to detect whether the specified port of the at least one candidate terminal device is activated; where it is determined, on receiving the connection request, that the specified port of the at least one candidate terminal device is activated.

In a possible implementation, the acquiring service state information of the at least one target terminal device includes: acquiring the service state information reported, based on a universal plug and play protocol, by the at least one target terminal device, where the service state information is sent, based on the universal plug and play protocol, to the mobile terminal by the at least one target terminal device after accessing the wireless local area network.

In another aspect, an information prompting apparatus is further provided in the present disclosure. The information prompting apparatus includes:
a device detection unit, configured to detect, in response to a first media player application of a mobile terminal initiating multimedia playback and the mobile terminal being in a wireless local area network of a specified type, whether at least one candidate terminal device other than the mobile terminal is in the wireless local area network;
a port detection unit, configured to detect, in response to the at least one candidate terminal device being in the wireless local area network, whether a specified port of the at least one candidate terminal device is activated, where activation of the specified port of the at least one candidate terminal device indicates that the candidate terminal device is associated with a screen of a preset type; and
a first prompt unit, configured to output, in response to the at least one candidate terminal device including at least one target terminal device whose specified port is activated, a first icon prompt to a multimedia playback window of the first media player application, where the first icon prompt is for prompting existence of a terminal device with the screen of the preset type in the wireless local area network where the mobile terminal is located.

In a possible implementation, the information prompting apparatus further includes:
an address acquisition unit, configured to acquire, in response to the at least one candidate terminal device including the at least one target terminal device whose specified port is activated, a first media access control address of the at least one target terminal device and a second media access control address of a router in the wireless local area network;
a record query unit, configured to determine, for each of the at least one target terminal device, whether an access record of the target terminal device is in an application server based on the first media access control address of the target terminal device and the second media access control address of the router, where the application server is capable of outputting projection content and corresponds to a second media player application of a specified type; and
a second prompt unit, configured to output, in response to the access record of the at least one target terminal device being in the application server, a second icon prompt to the multimedia playback window of the first media player application, where the second icon prompt is for prompting existence of a terminal device with the screen of the preset type and installed with the second media player application in the wireless local area network.

In a possible implementation, the information prompting apparatus further includes: a third prompt unit, configured to output, in response to none of the access record of the at least one target terminal device being in the application server, a third icon prompt to the multimedia playback window of the first media player application, where the third icon prompt is for prompting a user to install the second media player application on the terminal device with the screen of the preset type in the wireless local area network.

From the above descriptions, it can be seen that in the embodiments of the present disclosure, in a case where the media player application of the mobile terminal initiates multimedia playback and the mobile terminal is in the specified wireless local area network, the mobile terminal may detect whether a terminal device associated with a screen of a preset type is in the wireless local area network. The first icon prompt is outputted to the multimedia playback window of the mobile terminal only when the mobile terminal is in the wireless local area network and the terminal device associated with the screen of the preset type is in the wireless local area network. Therefore, with the first icon prompt, the user can determine that the mobile terminal is in the wireless local area network and that the terminal device with the screen of the preset type for projection accesses the wireless local area network. In this way, a situation where the user blindly initiates projection under a condition that the network environment where the mobile terminal is located does not support projection can be reduced, thereby reducing resources consumption in processing a projection operation due to blindly initiating the projection.

### BRIEF DESCRIPTION OF THE DRAWINGS

For clearer illustration of the technical solutions according to embodiments of the present disclosure, the drawings to be applied in embodiments of the present disclosure are briefly described hereinafter. Apparently, the drawings in the following descriptions are only embodiments of the present disclosure, and other drawings may be obtained by those skilled in the art based on the drawings without any creative effort.

FIG. 1 shows a schematic flow chart of an information prompting method according to an embodiment of the present disclosure;

FIG. 2 shows a schematic flow chart of an information prompting method according to another embodiment of the present disclosure; and

FIG. 3 shows a schematic structural diagram of an information prompting apparatus according to an embodiment of the present disclosure.

### DETAILED DESCRIPTION

It is found from researches that during a media player application playing multimedia on a mobile terminal, a projection icon is displayed on a multimedia playback interface of the media player application. The projection icon only indicates that the media player application supports projection, rather than indicating whether the mobile terminal accesses a wireless local area network that supports projection or whether a large-screen smart device capable of outputting projection content is in the wireless local area network which the mobile terminal accesses. Based on this, a user often blindly initiates projection by clicking on the projection icon without determining whether an environment in which the mobile terminal is located supports projection. As a result, there is often a situation where the multimedia playback of the mobile terminal is interrupted and the projection is failed, and resources consumed by the mobile terminal for processing the projection are wasted.

Based on the above research, with the solution of the present disclosure, a network environment in which the mobile terminal is located and a device in the network environment in which the mobile terminal is located are detected when the media player application of the mobile terminal initiates multimedia playback, and an accurate and detailed prompt is provided for users based on a detection result. In this way, the situation where the user blindly initiates projection is reduced, and thereby the resource consumption of the mobile terminal and the interruption of multimedia playback due to blind projection can be reduced.

Hereinafter technical solutions of embodiments of the present disclosure are described clearly and completely in conjunction with the drawings of the embodiments of the present disclosure. Apparently, the embodiments described below are only some embodiments, rather than all the embodiments of the present disclosure. Any other embodiments obtained by those skilled in the art based on the embodiments in the present disclosure without any creative effort shall fall within the protection scope of the present disclosure.

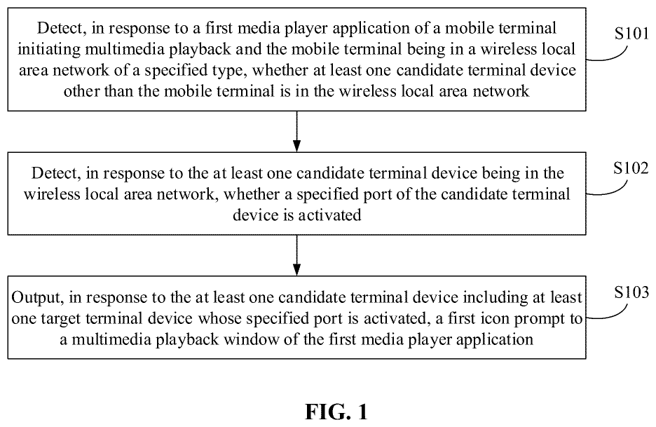

Reference is made to FIG. 1, which shows a flow chart of an information prompting method according to an embodiment of the present disclosure. The information prompting method in the embodiment is applicable to a mobile terminal, which is a client where a media player application is installed. The information prompting method according to the embodiment includes the following S101 to S103.

In S101, in a case where a first media player application of a mobile terminal initiates multimedia playback, and the mobile terminal is in a wireless local area network of a specified type, it is detected whether at least one candidate terminal device other than the mobile terminal is in the wireless local area network.

The media player application on the mobile terminal is referred to as the first media player application, in order to distinguish the first media player application from a media player application on other devices other than the mobile terminal.

The first media player application may be referred to as a multimedia player, which is an application that supports multimedia playback, including videos. For example, the first media player application may be a digital media player (DMP).

Apparently, the first media player application may be any other type of multimedia player. The first media player may differ depending on developers, which is not limited here.

It should be understood that projection of the mobile terminal generally requires the mobile terminal to be in a preset wireless local area network. Based on this, in the present disclosure, after a user plays multimedia through the first media player application on the mobile terminal, the first media player application detects whether the mobile terminal accesses the wireless local area network of the specified type.

The wireless local area network of the specified type may be a wireless fidelity (WiFi) network. Apparently, the wireless local area network may vary in type based on both specific application scenarios of the mobile terminal and ongoing technological advancements, which may be determined depending on requirements and is not limited here.

There may be many ways to determine whether the mobile terminal accesses the wireless local area network. For example, a registration broadcast may be performed on the wireless local area network when the first media player application is started, so that a broadcast notification is received by the mobile terminal, when accesses or disconnected from the wireless local area network, thereby determining whether the mobile terminal accesses the wireless local area network. Apparently, there may be other ways to detect whether the mobile terminal accesses the wireless local area network of the specified type, which is not limited here.

In the present disclosure, in a case where no other terminal device is in the wireless local area network which the mobile terminal accesses, the multimedia played on the mobile terminal fails to be projected onto other terminal device. Therefore, in the present disclosure, it is further detected whether there is another terminal device in the wireless local area network. For the convenience of distinction, a terminal device other than the mobile terminal in the wireless local area network is referred to as a candidate terminal device. The candidate terminal device may be any type of communication terminal.

There may be many ways to detect whether a candidate terminal device other than the mobile terminal is in the wireless local area network, which is not limited in the present disclosure.

For ease of understanding, an implementation of detecting whether a candidate terminal device is in the wireless local area network is described in the present disclosure.

First, a first Internet Protocol (IP) address of the mobile terminal may be obtained.

Then, multiple second IP addresses configurable in the wireless local area network other than the first IP address are determined.

For example, 255 IP addresses may generally be configured in a wireless local area network. Therefore, after the first IP address of the mobile terminal is determined, remaining 254 network addresses configurable in the wireless local area network may be determined. For example, assuming that the first IP address is 192.168.0.1, and 253 IP addresses from 192.168.0.2 to 192.168.0.254 and an IP address 192.168.0.0 may be configured in the wireless local area network.

Then, a test packet is sent to each of the second IP addresses to determine whether a candidate terminal device corresponding to the second IP address is in the wireless local area network.

For each of the second IP addresses, a test response packet returned from the second IP address is received after the test packet is sent to the second IP address, it indicates that a candidate terminal device corresponding to the second IP address is in the wireless local area network. The test response packet is a response data packet regarding the test packet.

In a case where a test response packet returned from at least one second IP address is received, it is determined that at least one candidate terminal device corresponding to the at least one second IP address is in the wireless local area network.

The test packet sent to the second IP address may be a Ping test command sent through a Packet Internet Groper (Ping). Here, Ping is a program for testing network connectivity.

Apparently, the test packet may be sent by means of other messages of the Internet Control Message Protocol (ICMP), which is not limited here.

In an alternative implementation, considering that the mobile terminal has a great demand for projection during playing a high-definition video, in the present disclosure, the above step S101 and subsequent related operations may be performed in a case where the first media player application of the mobile terminal initiates playback of a high-definition video.

In S102, in a case where the at least one candidate terminal device is in the wireless local area network, it is detected whether a specified port of the candidate terminal device is activated.

The activation of the specified port of the candidate terminal device indicates that the candidate terminal device is associated with a screen of a preset type.

It should be understood that the purpose of projection is to improve a viewing effect of multimedia. Therefore, there are some requirements on a screen of a terminal device that supports projection from the mobile terminal. In the present disclosure, the terminal device that meets the requirement for projection from the mobile terminal is a terminal device associated with the screen of the preset type.

The terminal device associated with the screen of the preset type generally has a specified port that is activated. Therefore, by detecting whether the specified port of the candidate terminal device is activated, it can be determined whether the candidate terminal device is the terminal device associated with the screen of the preset type.

The screen of the preset type may be determined as required, and the specified port may be vary depending on a specific requirement of the screen of the preset type.

For example, in the present disclosure, the screen of the preset type may be a screen with a dimension or area exceeding a preset threshold. Based on this, the terminal device associated with the screen of the preset type may be commonly referred to as a large-screen smart device, such as a smart television, or a smart set-top box device able to connect a screen or a projection screen, which is not limited here. For the large-screen smart device, it is detected whether a port 5555 is activated to determine the large-screen smart device.

In the present disclosure, there are multiple ways to detect whether the specified port of the candidate smart device is activated.

For example, a connection request may be sent to the specified port of the candidate terminal device to detect whether the specified port of the candidate terminal device is activated. In this case, if a response to the connection request is received, it is determined that the specified port of the candidate terminal device is activated.

For example, the mobile terminal may send a socket connection request to the specified port of the candidate terminal device through a network layer. If the connection fails, it is determined that the specified port of the candidate terminal device is not activated; and otherwise, if the connection is successful, it is determined that the specified port of the candidate terminal device is activated.

For another example, the Ping test mentioned above may be applied to send a Ping command to the specified port of the candidate terminal device to test whether the specified port of the candidate terminal device is activated. Apparently, there may be other test ways, which is not limited here.

In S103, in a case where the at least one candidate terminal device includes at least one target terminal device whose specified port is activated, a first icon prompt is outputted to a multimedia playback window of the first media player application.

The first icon prompt is for prompting existence of a terminal device with the screen of the preset type in the wireless local area network where the mobile terminal is located. With the first icon prompt, the user may be aware of existence of a terminal device that meets a projection requirement from the mobile terminal in the wireless local area network.

For example, the first icon prompt may indicate that a large-screen smart device is in the WiFi network, so that the user can know that the large-screen smart device that meets the projection requirement from the mobile terminal is in the WiFi network.

In the present disclosure, the first icon prompt may be implemented in several forms.

For example, the first icon prompt may be a prompt bar with prompt information.

To achieve a better prompt effect, the first icon prompt may be a prompt icon having a function of prompting that “the terminal device with the screen of the preset type is in the wireless local area network where the mobile terminal is located”. The prompt icon may be permanently presented in the multimedia playback window of the first media player application; or may be hidden after being displayed on the multimedia playback window for a period of time, and may be presented again on detection of a specific operation.

In a possible implementation, after determining the existence of the target terminal device whose specified port is activated in the wireless local area network where the mobile terminal is located, the first media player application of the mobile terminal sends a first indication to a server of the first media player application. The first indication is for indicating the existence of the target terminal device whose specified port is activated in the wireless local area network where the mobile terminal is located. Based on this, the server may generate the first icon prompt and feed the first icon prompt back to the first media player application, and the first media player application may output the first icon prompt.

In an embodiment, considering that multiple target terminal devices whose specified ports are activated may be in the wireless local area network where the mobile terminal is located, in order to enable the user to determine the specific target terminal devices, a list of the at least one target terminal device may be displayed on detection of a click on the first icon prompt.

From the above descriptions, it can be seen that in the present disclosure, in a case where the media player application of the mobile terminal initiates multimedia playback and the mobile terminal is in the wireless local area network of the specified type, the mobile terminal may detect whether a terminal device associated with a screen of a preset type is in the wireless local area network. The first icon prompt is outputted to the multimedia playback window of the mobile terminal only when the mobile terminal is in the wireless local area network and the terminal device associated with the screen of the preset type is in the wireless local area network. Therefore, with the first icon prompt, the user can determine that the mobile terminal is in the wireless local area network and that the terminal device with the screen of the preset type for projection accesses the wireless local area network. In this way, a situation where the user blindly initiates projection under a condition that the network environment where the mobile terminal is located does not support projection can be reduced, thereby reducing resources consumption in processing a projection operation due to blindly initiating the projection.

In addition, with the first icon prompt, the user can determine a network environment where the mobile terminal is located and whether the terminal device for projection is in the network environment, so that a situation of affecting normal multimedia playback by projection failure due to blind initiation of projection can be reduced, thereby reducing a situation where multimedia playback is interrupted due to projection failure.

It should be understood that after the mobile terminal accesses the wireless local area network of the specified type and a target terminal device whose specified port is activated is in the wireless local area network, although it can be determined that a device meeting the projection requirement is in the wireless local area network where the mobile terminal is located, it cannot be determined that the target terminal device supports projection or currently meets a condition for projection.

Based on this, in order to further prompt in detail a possible application with which the mobile terminal is allowed to initial projection, in the present disclosure, it may be further analyzed whether a multimedia player application supporting projection is installed on the target mobile terminal, whether the multimedia player application is started, and the like, and more detailed information prompts may be provided.

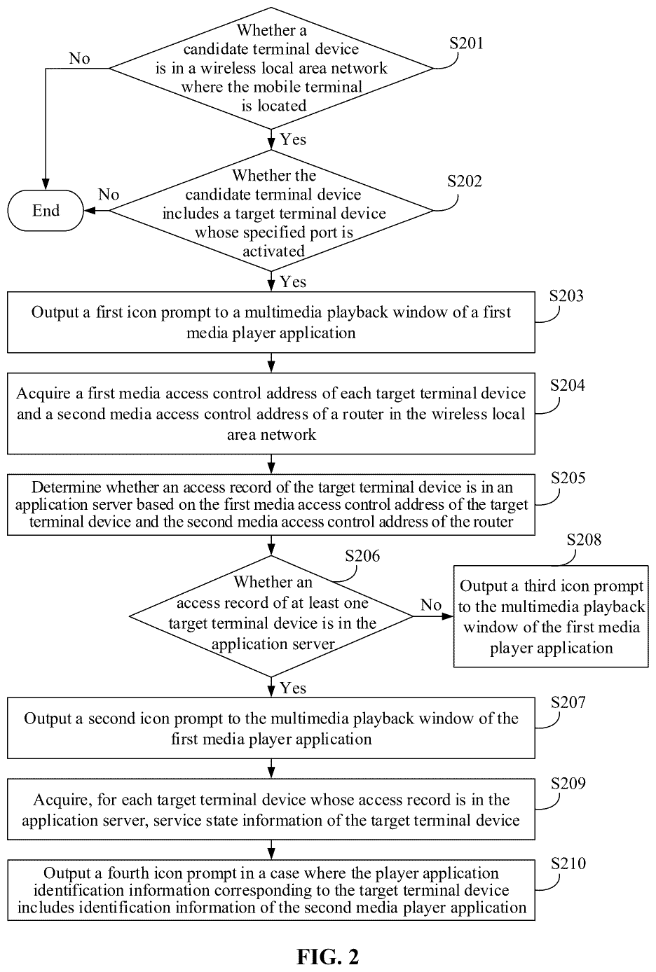

The information prompting method is explanted in conjunction with specific implementations. Reference is made to FIG. 2, which shows a schematic flow chart of an information prompting method according to another embodiment of the present disclosure. In the embodiment, the method includes the following S201 to S210.

In S201, in a case where a first media player application of a mobile terminal initiates multimedia playback, and the mobile terminal is in a wireless local area network of a specified type, it is detected whether at least one candidate terminal device other than the mobile terminal is in the wireless local area network. The process proceeds to step S202 on detecting that the at least one candidate terminal device is in the wireless local area network; and the process terminates on detecting that no candidate terminal device is in the wireless local area network.

In S202, it is detected whether the at least one candidate terminal device includes at least one target terminal device whose specified port is activated. The process proceeds to step S203 in a case of existence of the at least one target terminal device; and the process terminates in a case of absence of the at least one target terminal device.

The activation of the specified port of the candidate terminal device indicates that the candidate terminal device is associated with a screen of a preset type. For example, as described above, it may be determined whether the candidate terminal device is a large-screen smart device by detecting whether a port 5555 of the candidate terminal device is activated.

In S203, a first icon prompt is outputted to a multimedia playback window of the first media player application.

The first icon prompt is for prompting existence of a terminal device with the screen of the preset type in the wireless local area network where the mobile terminal is located.

For the steps S201 to S203, reference may be made to the related description in the foregoing embodiments, which is not repeated here.

In S204, a first media access control address of each target terminal device and a second media access control address of a router in the wireless local area network are acquired.

In the embodiment, in a case where the at least one candidate terminal device includes at least one target terminal device whose specified port is activated, step S204 is performed in addition to step S203. An execution order of these two steps is not limited to that shown in FIG. 2. In practical applications, the two steps may be performed in parallel or in a reversed order.

The media access control (MAC) address, also known as a local area network address, Ethernet address or physical address, is an address for determining a location of a network device.

For ease of distinction, in the present disclosure, a MAC address of the target terminal device is referred to as the first MAC address, and a MAC address of the router is referred to as the second MAC address. The MAC address of the router is the MAC address of a site, that is, BSSID.

In the present disclosure, the MAC address of the target terminal device and the MAC address of the wireless local area network are acquired in many manners, and the manners are not limited here.

In a possible implementation, a MAC address corresponding to the second IP address of the target terminal device in the wireless local area network may be acquired based on an address resolution protocol (ARP). The ARP protocol is a TCP/IP protocol for obtaining a physical address based on an IP address.

For example, after any one terminal device in the wireless local area network accesses the wireless local area network, the terminal device reports the MAC address of the terminal device to the router, and the router retains a correspondence between the IP address and the MAC address of each terminal device. Based on this, the mobile terminal in the wireless local area network may request a MAC address corresponding to each of the second IP addresses from the router based on the ARP protocol, to obtain the first MAC address of the target terminal device.

As for the router, after the IP address of the router is determined, the MAC address of the router may be requested directly from the router. For a mobile terminal with Android system, when the wireless local area network accessed by the mobile terminal is a WiFi network, the MAC address of the router in the WiFi network may be obtained through a WiFi Manager interface.

In S205, for each of the target terminal devices, it is determined whether an access record of the target terminal device is in an application server based on the first media access control address of the target terminal device and the second media access control address of the router.

The application server is capable of outputting projection content and corresponds to a second media player application of a specified type.

The first media player application may be different from the second media player application in type.

In an implementation, the first media player application and the second media player application may be developed by a same developer and adapted to different types of devices. For example, the first media player application may be developed by an application developer M for mobile devices, and the second media player application may be developed by the application developer M for large-screen smart terminals such as smart televisions. The application server may be an application server for the first media player application and the second media player application.

It can be understood that in a case where the application server of the second media player application contains an access record corresponding to the second MAC address of the target terminal device and an access record corresponding to the second MAC address of the router in the wireless local area network, it is determined that the target terminal device historically logged in to the application server through the second media player application and through the wireless local area network, which naturally means that the second media player application is installed on the target terminal device.

Furthermore, in the present disclosure, in order to accurately determine an installation state of the second media player application on the target terminal device, it may be focused on whether the target terminal device accessed the application server of the second media player application within a preset recent period of time. In this case, it is determined whether an access record of the target terminal device is in the application server of the second media player application within the recent period of time based on the first MAC address of the target terminal device and the second MAC address of the router.

The preset recent period of time may be set as needed. For example, the preset recent period of time may be a last month or a last 15 days, which is not limited here.

In S206, it is determined whether the access record of at least one target terminal device is in the application server. The process proceeds to step S207 in a case of existence of such access record; and the process proceeds to S208 in a case of absence of such access record.

In S207, a second icon prompt is outputted to the multimedia playback window of the first media player application.

The second icon prompt is for prompting existence of a terminal device with the screen of the preset type and installed with the second media player application in the wireless local area network.

The second icon prompt is different from the first icon prompt.

Similar to forms of the first icon prompt, the second icon prompt may be implemented in several forms. For example, the second icon prompt may be a prompt bar with prompt information. Alternatively, to achieve a better prompt effect, the second icon prompt may be an icon for prompting that “the terminal device with the screen of the preset type and installed with the second media player application is in the wireless local area network where the mobile terminal is located”. The icon may be permanently presented in the multimedia playback window of the first media player application; or may be hidden after being displayed in the multimedia playback window for a period of time, and may be presented again on detection of a specific operation.

In the present disclosure, the first icon prompt and the second icon prompt are independent from each other.

Furthermore, in order to enable the user to determine which target terminal devices are installed with the second media player application, a list of the target terminal devices may be presented after the user clicks the first icon prompt. In the list, the second icon prompt is marked for the target terminal device installed with the second media player application.

Based on the prompt function of the second icon prompt, the user can know, from the second icon prompt, that the target terminal device with the screen of the preset type is in the wireless local area network where the mobile terminal is located, and the target terminal device is installed with the second media player application and thereby can support projection from the mobile terminal to the screen of the target terminal device. On this basis, the user is allowed to determine whether to initiate projection as needed, avoiding blind initiation of projection.

In S208, a third icon prompt is outputted to the multimedia playback window of the first media player application, and then the process terminates.

The third icon prompt is for prompting the user to install the second media player application on the terminal device with the screen of the preset type in the wireless local area network.

In a case where none of access records of the target terminal devices is in the application server, it indicates that the terminal device with the screen of the preset type and installed with the second media player application is not in the wireless local area network where the mobile terminal is located. Based on this, in order to enable the user to have a better multimedia effect through projection, in the present disclosure, the third icon prompt may be provided to prompt the user to install the second media player application, thereby ensuring reliable projection from the mobile terminal, and popularizing the second media player application.

The third icon prompt may be implemented in several forms. For example, the third icon prompt may be a static icon, or a displayed static or dynamic prompt bar, which is not limited here.

It can be understood that step S208 is an optional step, and may be performed or may not be performed as needed in an actual application.

It can be understood that it is not required to perform step S209 and other subsequent operations in a case where no access record of at least one target terminal device is in the application server.

In S209, for each target terminal device whose access record is in the application server, service state information of the target terminal device is acquired.

The service state information of the target terminal device is information of a service provided by the target terminal device. In the present disclosure, the service state information includes player application identification information of a player application currently started and running on the target terminal device, where the player application identification information may include one or more of a name, an identification, or other information of the player application.

The service state information of the target terminal device may be sent to each device in the wireless local area network when the target terminal device accesses the wireless local area network. The service state information may be updated regularly.

For example, in a possible implementation, service state information reported by the target terminal device based on a universal plug and play (UPNP) protocol may be acquired. Such service state information is sent to the mobile terminal based on the UPNP protocol after the target terminal device accesses the wireless local area network.

The steps S209 and S207 may be performed in parallel or in a reversed order, which is not limited here.

In S210, a fourth icon prompt is outputted in a case where the player application identification information corresponding to the target terminal device includes identification information of the second media player application.

The fact that the player application identification information corresponding to the target terminal device includes the identification information of the second media player application may indicate that the second media player application is currently started on the target terminal device.

The fourth icon prompt is for prompting the user that a terminal device capable of projection is in the wireless local area network.

For example, the second media player application is a DMP of a designated merchant, and therefore it is necessary to check whether the identification information of the DMP of the designated merchant is included in the player application identification of the player application started in the target terminal device. In a case of inclusion, it is determined that the DMP of the designated merchant is already started on the target terminal device. Based on this, the mobile terminal may output the fourth icon prompt for prompting that the multimedia is allowed to be projected onto the second media player application, i.e., DMP of the designated merchant.

In the present disclosure, the fourth icon prompt may be implemented in several forms, such as a fixedly displayed icon or a dynamic prompt bar, which is not limited here.

It is understood that existence of the access record of the target terminal device in the application server only indicates that the second media player application is installed on the target terminal device. In a case where the second media player application on the target terminal device is not started, the user fails to directly initiate projection to the second media player application on the target terminal device through the mobile terminal. The user may first start the second media player application or choose another method with a poorer projection effect.

Based on this, in an embodiment, in a case of existence of the access record of the target terminal device in the application server, it may be further determined whether a media player application is started on the target terminal device, and a corresponding prompt may be provided. In this way, the user can understand, from the prompt, a state of the target terminal device in the wireless local area network where the mobile terminal is located more comprehensively and in detail, so that more detailed information basis is provided for the user to decide whether to initiate projection.

It can be understood that in order to analyze the network environment in which the mobile terminal is located and the relevant state of other terminal devices in the network environment when the first media player application of the mobile terminal initiates multimedia playback, that is, to perform the relevant operations of the above embodiments of the present disclosure, a software development kit (SDK) may be pre-installed in the first media player application according to the present disclosure. Thereby, when the first media player application initiates multimedia playback, the SDK program is started, and the above-mentioned operations such as determining whether the mobile terminal is in the wireless local area network of the specified type, determining whether a target terminal device whose specified port is activated is in the wireless local area network, and analyzing the service state information of the target terminal device, are performed through the SDK.

Corresponding to the information prompting method according to the present disclosure, an information prompting apparatus is further provided in the present disclosure.

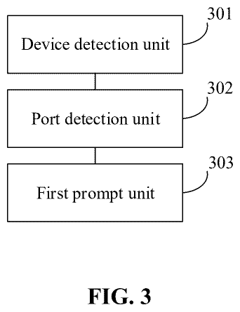

Reference is made to FIG. 3, which shows a schematic structural diagram of an information prompting apparatus according to an embodiment of the present disclosure. The information prompting apparatus according to the embodiment may include a device detection unit 301, a port detection unit 302, and a first prompt unit 303.

The device detection unit 301 is configured to detect, in response to a first media player application of a mobile terminal initiating multimedia playback and the mobile terminal being in a wireless local area network of a specified type, whether at least one candidate terminal device other than the mobile terminal is in the wireless local area network.

The port detection unit 302 is configured to detect, in response to the at least one candidate terminal device being in the wireless local area network, whether a specified port of the candidate terminal device is activated, where activation of the specified port of the candidate terminal device indicates that the candidate terminal device is associated with a screen of a preset type.

The first prompt unit 303 is configured to output, in response to the at least one candidate terminal device including at least one target terminal device whose specified port is activated, a first icon prompt to a multimedia playback window of the first media player application. The first icon prompt is for prompting existence of a terminal device with the screen of the preset type in the wireless local area network where the mobile terminal is located.

In a possible implementation, the information prompting apparatus further includes an address acquisition unit, a record query unit, and a second prompt unit.

The address acquisition unit is configured to acquire, in response to the at least one candidate terminal device including the at least one target terminal device whose specified port is activated, a first media access control address of the target terminal device and a second media access control address of a router in the wireless local area network.

The record query unit is configured to determine, for each of the at least one target terminal device, whether an access record of the target terminal device is in an application server based on the first media access control address of the target terminal device and the second media access control address of the router, where the application server is capable of outputting projection content and corresponds to a second media player application of a specified type.

The second prompt unit is configured to output, in response to the access record of the at least one target terminal device being in the application server, a second icon prompt to the multimedia playback window of the first media player application. The second icon prompt is for prompting existence of a terminal device with the screen of the preset type and installed with the second media player application in the wireless local area network.

In a possible implementation, the information prompting apparatus further includes a third prompt unit.

The third prompt unit is configured to output, in response to none of the access record of the at least one target terminal device being in the application server, a third icon prompt to the multimedia playback window of the first media player application. The third icon prompt is for prompting a user to install the second media player application on the terminal device with the screen of the preset type in the wireless local area network.

In a possible implementation, the information prompting apparatus further includes a state acquisition unit and a fourth prompt unit.

The state acquisition unit is configured to acquire, in response to the access record of the at least one target terminal device being in the application server, service state information of the at least one target terminal device. The service state information includes player application identification information of a player application currently started and running on the at least one target terminal device.

The fourth prompt unit is configured to output a fourth icon prompt in response to the player application identification information corresponding to the at least one target terminal device including identification information of the second media player application. The fourth icon prompt is for prompting a user that a terminal device capable of projection is in the wireless local area network.

In a possible implementation, the device detection unit includes a first IP obtaining unit, a second IP obtaining unit, and a device test unit.

The first IP obtaining unit is configured to obtain a first IP address of the mobile terminal.

The second IP obtaining unit is configured to determine multiple second IP addresses configurable in the wireless local area network other than the first IP address.

The device test unit is configured to send a test packet to each of the second IP addresses to determine whether a candidate terminal device corresponding to the second IP address in the wireless local area network.

The process of determining, by the port detection unit, that at least one candidate terminal device in the wireless local area network includes: determining, on receiving a test response packet returned from at least one of the multiple second IP addresses, that the at least one candidate terminal device corresponding to the at least one second IP address is in the wireless local area network, where the test response packet is a response data packet regarding the test packet.

In a possible implementation, the port detection unit includes a connection request sub-unit.

The connection request sub-unit is configured to send a connection request to the specified port of the candidate terminal device to detect whether the specified port of the candidate terminal device is activated, where it is determined, on receiving the connection request, that the specified port of the candidate terminal device is activated.

It should be noted that the embodiments in the present disclosure are described in a progressive manner, and each of the embodiments focuses on its differences from the other embodiments. The same and similar parts among the embodiments may be referred to each other. In addition, the features recorded in the embodiments in this specification may be replaced or combined with each other so as to enable those skilled in the art to implement or use the present disclosure. The device embodiments are essentially similar to the method embodiments, and therefore are described in brief. Reference may be made to the description of the method embodiments for relevant details of the device embodiments.

It should be further noted that in the present disclosure, the relationship terminologies such as “first” and “second” are only used to distinguish one entity or operation from another entity or operation, rather than to necessitate or imply an actual relationship or order between the entities or operations. Moreover, terms “include”, “comprise” or any variants thereof are intended to be non-exclusive. Therefore, a process, method, article or device including a series of elements includes not only the elements but also other elements that are not enumerated, or further includes elements inherent to the process, method, article or device. Unless expressively limited otherwise, the statement “comprising (including) one . . . ” does not exclude existence of other similar elements in the process, method, article or device.

The above description of the disclosed embodiments enables those skilled in the art to implement or use the present disclosure. Various modifications to the embodiments are apparent to those skilled in the art, and the generic principles defined herein may be practiced in other embodiments without departing from the spirit or scope of the present disclosure. Therefore, the present disclosure is not to be limited to the embodiments shown herein but is to be conformed with the widest scope consistent with the principles and novel features disclosed herein.

Hereinabove described are only preferred embodiments of the present disclosure. It should be noted that improvements and modifications can be made by those of ordinary skills in the art, without departing from the principles of the present disclosure. Such improvements and modifications fall within the protection scope of the present disclosure.

1. An information prompting method, comprising:
detecting, in response to a first media player application of a mobile terminal initiating multimedia playback and the mobile terminal being in a wireless local area network of a specified type, whether at least one candidate terminal device other than the mobile terminal is in the wireless local area network;
detecting, in response to the at least one candidate terminal device being in the wireless local area network, whether a specified port of the at least one candidate terminal device is activated, wherein activation of the specified port of the at least one candidate terminal device indicates that the candidate terminal device is associated with a screen of a preset type; and
outputting, in response to the at least one candidate terminal device comprising at least one target terminal device whose specified port is activated, a first icon prompt to a multimedia playback window of the first media player application, wherein the first icon prompt device with the screen of the preset type in the wireless local area network where the mobile terminal is located.

2. The information prompting method according to claim 1, further comprising:
acquiring, in response to the at least one candidate terminal device comprising the at least one target terminal device whose specified port is activated, a first media access control address of the at least one target terminal device and a second media access control address of a router in the wireless local area network;
determining, for each of the at least one target terminal device, whether an access record of the target terminal device is in an application server based on the first media access control address of the target terminal device and the second media access control address of the router, wherein the application server is capable of outputting projection content and corresponds to a second media player application of a specified type; and
outputting, in response to the access record of the at least one target terminal device being in the application server, a second icon prompt to the multimedia playback window of the first media player application, wherein the second icon prompt is for prompting existence of a terminal device with the screen of the preset type and installed with the second media player application in the wireless local area network.

3. The information prompting method according to claim 2, further comprising:
outputting, in response to none of the access record of the at least one target terminal device being in the application server, a third icon prompt to the multimedia playback window of the first media player application, wherein the third icon prompt is for prompting a user to install the second media player application on the terminal device with the screen of the preset type in the wireless local area network.

4. The information prompting method according to claim 2, further comprising:
acquiring, in response to the access record of the at least one target terminal device being in the application server, service state information of the at least one target terminal device, wherein the service state information comprises player application identification information of a player application currently started and running on the at least one target terminal device; and
outputting a fourth icon prompt in response to the player application identification information corresponding to the at least one target terminal device comprising identification information of the second media player application, wherein the fourth icon prompt is for prompting a user that a terminal device capable of projection is in the wireless local area network.

5. The information prompting method according to claim 1, wherein
the detecting whether at least one candidate terminal device other than the mobile terminal is in the wireless local area network comprises:
obtaining a first IP address of the mobile terminal;
determining a plurality of second IP addresses configurable in the wireless local area network other than the first IP address; and
sending a test packet to each of the plurality of second IP addresses to determine whether a candidate terminal device corresponding to the second IP address in the wireless local area network;
wherein determining that the at least one candidate terminal device is in the wireless local area network comprises:
determining, on receiving a test response packet returned from at least one of the plurality of second IP addresses, that the at least one candidate terminal device corresponding to the at least one second IP address is in the wireless local area network, wherein the test response packet is a response data packet regarding the test packet.

6. The information prompting method according to claim 1, wherein the detecting whether a specified port of the at least one candidate terminal device is activated comprises:
sending a connection request to the specified port of the at least one candidate terminal device to detect whether the specified port of the at least one candidate terminal device is activated,
wherein it is determined, on receiving the connection request, that the specified port of the at least one candidate terminal device is activated.

7. The information prompting method according to claim 4, wherein the acquiring service state information of the at least one target terminal device comprises:
acquiring the service state information reported, based on a universal plug and play protocol, by the at least one target terminal device, wherein the service state information is sent, based on the universal plug and play protocol, to the mobile terminal by the at least one target terminal device after accessing the wireless local area network.

8. An information prompting apparatus, comprising:
a device detection unit, configured to detect, in response to a first media player application of a mobile terminal initiating multimedia playback and the mobile terminal being in a wireless local area network of a specified type, whether at least one candidate terminal device other than the mobile terminal is in the wireless local area network;
a port detection unit, configured to detect, in response to the at least one candidate terminal device being in the wireless local area network, whether a specified port of the at least one candidate terminal device is activated, wherein activation of the specified port of the at least one candidate terminal device indicates that the candidate terminal device is associated with a screen of a preset type; and
a first prompt unit, configured to output, in response to the at least one candidate terminal device comprising at least one target terminal device whose specified port is activated, a first icon prompt to a multimedia playback window of the first media player application, wherein the first icon prompt is for prompting existence of a terminal device with the screen of the preset type in the wireless local area network where the mobile terminal is located.

9. The information prompting apparatus according to claim 8, further comprising:
an address acquisition unit, configured to acquire, in response to the at least one candidate terminal device comprising the at least one target terminal device whose specified port is activated, a first media access control address of the at least one target terminal device and a second media access control address of a router in the wireless local area network;
a record query unit, configured to determine, for each of the at least one target terminal device, whether an access record of the target terminal device is in an application server based on the first media access control address of the target terminal device and the second media access control address of the router, wherein the application server is capable of outputting projection content and corresponds to a second media player application of a specified type; and
a second prompt unit, configured to output, in response to the access record of the at least one target terminal device being in the application server, a second icon prompt to the multimedia playback window of the first media player application, wherein the second icon prompt is for prompting existence of a terminal device with the screen of the preset type and installed with the second media player application in the wireless local area network.

10. The information prompting apparatus according to claim 9, further comprising:
a third prompt unit, configured to output, in response to none of the access record of the at least one target terminal device being in the application server, a third icon prompt to the multimedia playback window of the first media player application, wherein the third icon prompt is for prompting a user to install the second media player application on the terminal device with the screen of the preset type in the wireless local area network.
